(19) United States
(12) Patent Application Publication
(10) Pub. No.: US 2013/0322288 A1
(43) Pub. Date: Dec. 5, 2013

(54) METHOD OF DETERMINING A CHANNEL STATE IN COORDINATED MULTIPOINT TRANSMISSION

(71) Applicants: Xiaobo Zhang, Shanghai (CN); Huan Sun, Shanghai (CN)

(72) Inventors: Xiaobo Zhang, Shanghai (CN); Huan Sun, Shanghai (CN)

(73) Assignee: Alcatel Lucent, Paris (FR)

(21) Appl. No.: 13/985,988

(22) PCT Filed: Jan. 5, 2012
(86) PCT No.: PCT/IB2012/000159

§ 371 Date: Aug. 16, 2013

(30) Foreign Application Priority Data
Feb. 17, 2011 (CN) 201110039639.7

(51) Int. Cl. H04B 7/02

(52) U.S. Cl. CPC H04B 7/024
USPC 370/252; 370/329

(57) ABSTRACT

In order to reduce the feedback overhead of channel state information in Coordinated Multipoint (CoMP) transmission, the present invention provides a method of determining a channel state in the CoMP transmission, wherein the serving base station receives first channel state information with the serving base station and second channel state information with each of coordinated base stations, fed back by a user equipment; informing each coordinated base stations of the corresponding second channel state information; precoding a first reference signal according to the first channel state information, and sending the precoded first reference signal to the user equipment on the communication resource commonly used with the coordinated base station, wherein the first reference signal is superimposed with precoded second reference signals respectively sent by each of coordinated base stations; receiving third channel state information fed back by the user equipment according to the superimposed reference signal, and determining a channel state of the coordinated multipoint transmission corresponding to the user equipment, according to the first, second and third channel state information.

### FIELD OF THE INVENTION

The present invention relates to wireless communication technology, especially to the coordinated multipoint transmission technology.

### BACKGROUND OF THE INVENTION

CoMP(Coordinated Multipoint) transmission technology provides a candidate technique for improving the experience of the cell-edge user. The major challenges of CoMP technology include the backhaul latency, backhaul capacity, DL (Downlink) CSI (Channel State indicator) feedback, etc. The biggest problem of the challenges comes from the motivation of CoMP technique: inherently combining transmitting signals of multiple cells at the UE (User Equipment) side.

The typical JP (Joint Processing) CoMP requires the UE to report the DL CSI between itself and all the CoMP cells, which can be regarded as a KM×N matrix, wherein K,M,N are cell number, antenna number per cell, and antenna number of the UE respectively. This kind of CSI feedback can provide the possibility of global precoding at the eNB (evolved Node B) side. However, the feedback overhead and codebook search complexity may be too huge to be accepted.

A looser condition is: to make the UE feed back an independent M×N matrix for each of the K cells and perform the macro-diversity transmission. Several additional bits may be used to represent the cross-cell CSI phase/amplitude relationship. The cross-cell feedback requires the UE to know the active CoMP set, which may influence the scheduling flexibility of the scheduling and result in too much feedback.

### SUMMARY OF THE INVENTION

In LTE 3GPP R10 (Release 10), the PDSCH muting technology has been agreed in the industry to eliminate the inter-cell interference on CSI-RS (CSI-Reference Signal) RE (Resource Element)s, which means that there is some resource wasting on the muted REs. For example as shown by the resource allocation in FIG. 1, wherein the shading parts indicate the resource occupied by CRS (Common Reference Signal), the slash parts denote the resource occupied by CSI-RS of serving cells, and the backslash parts denotes the muted resource. For the CoMP transmission, CSI-RS may be cooperatively transmitted by a plurality of cells, as disclosed in Chinese patent application 201010253111.5 filed by the applicant.

Thus, the present invention proposes that the idle RE caused by PDSCH muting may be utilized. The coordinated CSI-RS may be located at the position (that is, communication resource) occupied by CSI-RS of the serving cell or the position occupied by CSI-RS of adjacent cells, which may be combined with a virtualized cell ID specifically served for CoMP, as the backslash parts in FIG. 1 may be used. The virtualized cell ID may be regarded as identification of CoMP coordinated group, and consists of 2 parts. The first part is the cooperatively scheduling cell group, such as 9 cells, and the second part is the cooperatively transmitting cell group within the cooperatively scheduling cell group, such as 3 cells.

Based on the aforesaid coordinated CSI-RS located in the muted RE or CSI-RS RE of the serving cell, the present invention provides a two-level CSI feedback technology.

In the first step, for the serving cell, the UE reports the first level CSI such as long-term CSI through the traditional method. For the coordinated cells (that is, non-serving cells) within the CoMP reporting set, the UE reports the first level CSI such as long-term/wide-band PMI (Precoding Matrix Indicator) according to CSI-RS or CRS.

In the second step, the UE reports the second step CSI such as short-term/narrow band RI (Rank Indication)/PMI/CQI (Channel Quality Indicator) according to the additional Reference Signals coordinatively transmitted by multiple cells.

The additional RS may be specifically indicated CSI-RS (beyond cell specific sub-frames), idle (that is, reserved and not used in current standard) DMRS (Demodulation RS) or newly defined RS, which may be narrow band and/or wide band. The CoMP transmitting points, namely the serving base station and the coordinated base station, perform precoding for the additional RS according to the reported first level CSI (and possible short-term. CSI for serving cell) and send to the UE. Then, base stations collect the second level CSI, fed back by the UE according to the superimposed precoding RS, and determine the channel state of the final CoMP transmission for the real data transmission.

The UE-specific DL signaling may be utilized to indicate the CSI-RS resources for generating the second level CSI, that is the communication resource on which the superimposed precoding RS is sent.

The serving cell may only use the Eigen-vector of the reported first level PMI, in order to reduce the required CSI-RS antenna ports (that is, number).

The importance of this solution is to reduce the UL (Uplink) overhead, because the two level feedbacks are virtually targeting one single cell, and the second level feedback is more short-term, for example a narrow band feedback, so as to further reduce the UL overhead.

To be specific, according to one aspect of the present invention, there is provided a method of determining a channel state, in a serving base station, wherein the serving base station performs a coordinated multipoint transmission with at least one coordinated base station, and the method comprises the following steps of:
informing, through a cell-specific signaling, a user equipment to measure a first reference signal sent by the serving base station on corresponding communication resource, the first reference signal is used for the user equipment to determine first channel state information;
sending the first reference signal on the corresponding communication resource; and
informing, through a cell-specific signaling, the user equipment to measure second reference signals respectively sent by each of coordinated base station on corresponding communication resource, the second reference signal is used for the user equipment to determine second channel state information;

a. receiving the first channel state information and each of second channel state information fed back by the user equipment.

In the preferable embodiment, when the feedback of the first and second channel state information is for example long-term state, the cell-specific signaling is used to inform the UE to measure for example in the form of broadcast, which may save the signaling overhead better.

According to one preferable embodiment, the method further comprises the following steps of:

b. informing each coordinated base stations of the corresponding second channel state information respectively;

c. precoding a third reference signal according to the first channel state information, and sending the precoded third reference signal to the user equipment on the communication resource commonly used with the coordinated base station, wherein the third reference signal is superimposed with precoded fourth reference signals respectively sent by each of coordinated base stations;

d. receiving third channel state information fed back by the user equipment according to the superimposed reference signal, and determining a channel state of the coordinated multipoint transmission corresponding to the user equipment, according to the first, second and third channel state information.

According to aforesaid preferable embodiment, the channel state of the coordinated multipoint transmission is indicated by the first, second and third channel state information which are with less information amount, which saves the overhead caused by the channel state measurement and feedback.

In one preferable embodiment, prior to the step a, the method further comprises the following steps of: sending to the UE the third RS for the UE to determine the first channel state information on the serving base station-specific communication resource. In the preferable embodiment, the first channel state information is determined by the UE according to the third RS sent by base stations.

In another preferable embodiment, before sending the third RS, the method further comprises:
informing, through a cell-specific signaling, the UE to measure the third RS on the serving base station-specific communication resource.

prior to the step a, the method further comprises:
informing, through a cell-specific signaling, the UE to measure the fourth reference signals respectively sent by each of coordinated base station on communication resource respectively specific for each of coordinated base station, to determine the second channel state information.

In the preferable embodiment, because the feedback of the first and second channel state information is for example long-term state, the cell-specific signaling is used to inform the UE to measure for example in the form of broadcast, which may save the signaling overhead better.

In another preferable embodiment, prior to the step c, the method further comprises: informing, through a cell-specific or user equipment-specific signaling, the UE to receive the superimposed third and fourth reference signals on the common communication resource. Because that the UE receives the superimposed RS to measure short-term/narrow-band state, the serving base station may inform through the UE-specific signaling, so the feedback speed is relative fast.

In another preferable embodiment, the method is used for MU-MIMO, and respectively determines the corresponding channel state of the coordinated multipoint transmission for each of a plurality of user equipments, the method further comprises:

e. determining a multi-users precoding matrix for the plurality of user equipments, based on the channel state of the coordinated multipoint transmission of each of the user equipments.

In the preferable embodiment, the method is used for MU-MIMO, which greatly reduces the overhead of the channel state feedback in MU-MIMO.

According to the second aspect of the present invention, there is provided a method of controlling channel state feedback, in a coordinated base station, wherein the coordinated base station performs a coordinated multipoint transmission with a serving base station, and the method comprises the following steps of:

i. receiving second channel state information between a user equipment and the coordinated base station, from the serving base station;

ii. precoding a fourth reference signal according to the second channel state information, and sending the precoded fourth reference signal to the user equipment on a communication resource commonly used with the serving base station, wherein the fourth reference signal is superimposed with a precoded third reference signal respectively sent by the serving base stations.

According to the third aspect of the present invention, there is provided a method of feeding back a channel state, in a user equipment, wherein a serving base station to which the user equipment belongs performs a coordinated multipoint transmission with at least one coordinated base station, and the method comprises the following steps of:

r. receiving an instruction indicating the user equipment to receive a first reference signal sent by the serving base station on corresponding communication resource, wherein the instruction is sent by the serving base station through a cell-specific signaling;

s. receiving an instruction indicating the user equipment to receive a second reference signal respectively sent by each of coordinated base station on corresponding communication resource, wherein the instruction is sent by the serving base station through a cell-specific signaling;

t. determining first channel state information with the serving base station according to the first reference signal, and respectively determining second channel state information with each of coordinated base stations according to respective one of the second reference signals;

u. feeding back the first and second channel state information to the serving base station.

According to another aspect of the present invention, there is provided a method of sending a reference signal to a user equipment in a serving base station, the serving base station performs a coordinated multipoint transmission with at least one coordinated base station, the method comprises the following steps of:
sending the reference signal on communication resource commonly used with the coordinated base station;

wherein the commonly used communication resource utilizes muted resource element of the physical downlink shared channel.

Furthermore, there is also provided a method of sending a reference signal to a user equipment in a coordinated base station, the coordinated base station performs a coordinated multipoint transmission with a serving base station, the method comprises the following step:
sending the reference signal on communication resource commonly used with the serving base station;

wherein the commonly used communication resource utilizes muted resource element of the physical downlink shared channel.

Furthermore, there is also provided a method of receiving a reference signal sent by base stations in a user equipment, a serving base station to which the user equipment belongs performs a coordinated multipoint transmission with at least one coordinated base station, the method comprises the following step:
receiving the reference signal on communication resource commonly used by the serving base station and the coordinated base stations;

wherein the commonly used communication resource utilizes muted resource element of the physical downlink shared channel.

In the aforesaid aspects, the muted resource element of the physical downlink shared channel is used, which improves the utilization ratio of resources.

The aforesaid feature and other features of the present invention will be explicitly illustrated in the following embodiments.

### BRIEF DESCRIPTION OF THE DRAWINGS

By reading the detailed description of the non-limiting embodiments with reference to the following drawings, other features, objects and advantages of the present invention will become apparent.

FIG. 1 is a schematic diagram of communication resources of CSI-RS for CoMP CSI feedback, according to one aspect of the present invention;

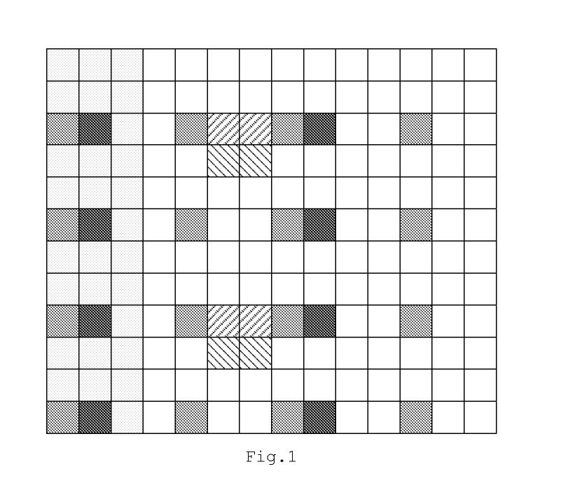

FIG. 2 is a performance simulation diagram of one embodiment of the present invention and the prior art.

### DETAILED DESCRIPTION OF EMBODIMENTS

In the followings, application of the inventive concept of the present invention in SU-MIMO will be described in detail in two embodiments, after that the application mode of the present invention in MU-MIMO will be illustrated.

### Embodiment 1

In the embodiment, it is illustrated in such CoMP scenario: there are three cells, which are respectively dominated by a base station with 4 transmitting antennas Tx. Wherein one serving cell and two coordinated cells (non-serving cells) are included, the serving cell serves one CoMP UE having 2 receiving antennas Rx, and the communication mode is FDD.

Firstly, the serving base station of the serving cell sends to the UE, on the specific communication resource, the first RS for the UE to determine the first channel state information with the serving base station. Moreover, each coordinated base stations sends to the UE, on specific communication resources, the second RSs respectively for the UE to determine the second channel state information with one coordinated base station.

Before this, preferably, the serving base station informs, through a cell-specific signaling, the UE to measure a first reference signal on the serving base station-specific communication resource, and informs, through a cell-specific signaling, the user equipment to measure second reference signals respectively sent by each of coordinated base station on communication resource specific for each of coordinated base station. The UE receives these notifications. The cell-specific signaling is SIB-2 signaling, for example. Because the feedback of the first and second channel state information is long-term state, for example, the cell-specific signaling is used to inform the UE to measure for example in the form of broadcast, which may save the signaling overhead better.

After receiving the first RS, the UE determines the first channel state information with the serving base station and feeds back the first channel state to the serving base station. And after receiving the second RS, the UE determines the second channel state information with each of coordinated base stations and feeds back the second channel state information to the serving base station. The way of determining channel state information according to the reference signal is known by those skilled in the art, which is not repeated again.

Preferably, in order to reduce feedback amount, the serving base station determines a rank for the first level PMI of the CoMP cell according to channel matrix H, here the rank for the serving cell is made as 2 and the rank for each of coordinated cells is made as 1.

Then, for the serving base station, the UE may use the traditional solution to report, for example, reporting a PMI W₁^{4×2} with the serving base station, which may be narrow-band, the dimension of this matrix W₁^{4×2} is in accordance with the number 4 of the transmitting antennas of the serving base station and the aforesaid rank 2. For the coordinated base stations, the UE reports a wide-band PMI W₂^{4×1},W₃^{4×1} (or a long-term PMI for R10 8Tx) with coordinated base stations, the dimensions of matrixes W₂^{4×1},W₃^{4×1} are in accordance with the number 4 of the transmitting antennas of the serving base station and the aforesaid rank 1.

After that, the serving base station respectively informs the corresponding coordinated base station of each of the second channel state information W₂^{4×1},W₃^{4×1}. Each of coordinated base stations receives the second channel state information from the serving base station.

After that, in case that the rank of PMI of the first level serving base station is 2, the serving base station may allocate two reference signal ports, that is, the third reference signal [s₁, s₂] is allocated.

Furthermore, in case that the rank of PMI of each of the first level coordinated base stations is 1, each of coordinated base stations may respectively allocate one reference signal ports, that is, the fourth reference signals s₃ and s₄ are respectively allocated.

Next, the serving base station precodes the third reference signal according to the first channel state information W₁^{4×2}. Each of coordinated base stations precodes the fourth reference signal according to the second channel state information. In addition, the serving base station and the coordinated base station respectively send to the UE the precoded the third reference signal and each of fourth reference signals on the communication resource commonly used with each other, wherein the third reference signal is superimposed with each of fourth reference signals. The method of precoding the reference signal according to the channel state information is the technical means known by those skilled in the art, and the specification will not repeat it again.

Before this, preferably, the serving base station informs, through a cell-specific or user equipment-specific signaling, the UE to receive the superimposed third and fourth reference signals on the common communication resource. Because that the UE receives the superimposed RS needs to measure short-term/narrow-band state, the serving base station may inform through the UE-specific signaling, so the feedback speed is relative fast.

Accordingly, the UE receives the superimposed precoded the third reference signal and all fourth reference signals, and determines the third channel state information (that is, the second level CSI), for example PMI ω. ω describes the phase offset between the channel matrix of the serving cell and the channel matrix of coordinated cells. The method that the UE determines the third channel state information according to the received superimposed reference signals has been described in the Chinese patent application 201010253111.5 filed by the applicant, and the relevant technical content recorded in the application is fully incorporated into this application.

Then, the UE feeds back PMI ω to the serving base station.

Finally, the serving base station recovers the final PMI for these three cells:

W₁^{4×2}·ω(1:2,:),W₂^{4×1}·ω(3,:),W₃^{4×1}·ω(4,:)

Wherein, ω(1:2, :) indicates the first two rows of elements of ω, ω(3, :) indicates the third row of elements of ω, ω(4, :) indicates the fourth row of elements of ω.

Alternatively, three reference signal ports s₁, s₂, s₃ may be allocated. The serving base station precodes the reference signal s₁ using W₁^{4×2} (:, 1), wherein W₁^{4×2} (:, 1) denotes the first column of elements of W₁^{4×2}. Two coordinated base stations precode reference signals s₂ and s₃ respectively using W₂^{4×1},W₃^{4×1}.

The UE feeds back the third channel state information PMI ω according to the superimposition of the aforesaid precoded reference signals. Specially, ω=[ω₁ ω₂] describes the phase offset between the channel matrix of the serving cell and the channel matrix of coordinated cells.

Finally, the serving cell recovers the final PMI for these three cells:

W₁^{4×2}, ω₁W₂^{4×1}, ω₂W₃^{4×1}.

### Embodiment 2

In the embodiment, it is illustrated in such CoMP scenario: there are two cells, which are respectively dominated by one base station with 4 transmitting antennas Tx. Wherein one serving cell and one coordinated cell (non-serving cell) are included, the serving cell serves one CoMP UE having 2 receiving antennas Rx, and the communication mode is FDD.

Similar to the aforesaid embodiment, the serving cell determines the rank of CoMP cell, and lets the ranks of the serving cell and coordinated cells as 1.

CoMP UE reports to the serving cell the wide-band SRS with the serving cell (implementing narrow-band and coded matrix W₁^{4×1} through SVD (Singular Value Decomposition)), and PMI with coordinated cells. The CSI report for coordinated cells is recorded as W₂^{4×1}.

Two reference signal ports s₁, s₂ are allocated and respectively precoded by the serving base station and coordinated base stations respectively using W₁^{4×1},W₂^{4×1}, and they are sent to the UE by being superimposed.

The UE feeds back the third channel state information PMIω. Specially, ω may be a scalar representing the phase difference between two cells.

Finally, the serving cell recovers the final PMI for these two cells:

W₁^{4×1},ωW₂^{4×1}

For MU-MIMO, the base station generally precodes based on the final PMI corresponding to each UE. The precoding matrix for a plurality of UEs may be obtained by transforming the final PMI corresponding to each UE. Implementations includes BD (Block Diagonalization), maximum SLR and RZFBF (Regular Zero-Forcing BeamForming). A example using RZFBF is described as follows, and the example uses implicit CQI/PMI.

For the jth UE, the final PMI of the single user rank 1 is recorded as \hat{V}ⱼ, and the CQI report is CQIⱼ. The precoding vector \hat{V} represents quantization of the precoding vector projected to the precoding subspace defined by the codebook, and \hat{ρ} denotes projecting energy in which noise/interference is considered.

For each hypothetical pairing of UEs, the precoding matrix F of multiple-users beamforming may be obtained by following formula:

F=[F₁ F₂]=V^{H}(V V^{H}+ρI)⁻¹

Wherein V^{H}=[\hat{V}ᵢ^{H}; \hat{V}₂^{H}], ρ is a regularizing factor (for example a heuristic function of geometry/SNR, or a constant). The multiple-users precoding vector for the jth UE is the kth column of the normalized F.

The gain of the present invention is that local precoding signals may be inherently combined without feeding back global CSI-RS by UE.

The inventor performs computer simulation for the performance of implementation of the present invention, and parameters used in the simulation are shown in the following table 1.

TABLE 1

| Parameter | Value | |
|---|---|---|
| Cell configuration | 3 | cells |
| Channel model | SCM-D | |
| Transmit enviroment | Umi | |
| User location | Random | |
| Number of antennas (Tx, Rx) | (4, 2) | |
| Antenna separation in | (4, 0.5) | |
| wavelength (Tx, Rx) | | |
| Other cell interference (OCI) | 0 | dB |
| CSI feedback | SRS for the serving cell, and | |
| | PMI for coordinated cells | |
| Carrier frequency | 2 | GHz |
| Subcarrier spacing | 15 | kHz |
| User speed | 1 | m/s |

| | |
|---|---|
| Preceding granularity | 2RB |
| UL and DL Channel estimation | FFT based CE for UL, and |
| | 2D-MMSE for DL |

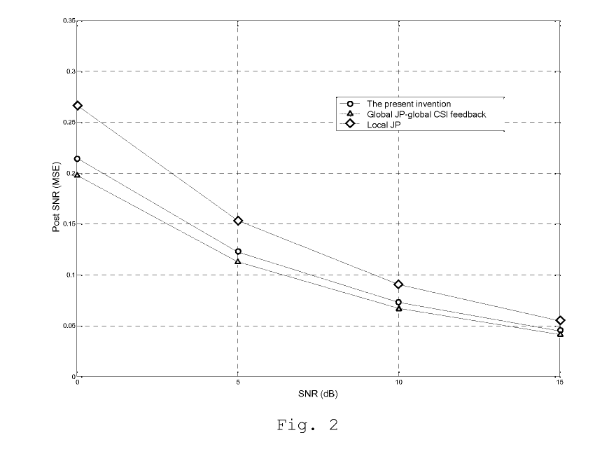

FIG. 2 shows performance curves of the present invention and the existing joint process solutions. From this it can be seen, the performance of the present invention is higher than that of the local joint process, and the CSI feedback overhead of the present invention is less than that of global joint process, which obtains better balance between performance and feedback overhead.

Those ordinary skilled in the art could understand and realize modifications to the disclosed embodiments, through studying the description, the disclosure, drawings and appended claims. The word “comprising” does not exclude the presence of elements or steps not listed in a claim or in the description. The word “a” or “an” preceding an element does not exclude the presence of a plurality of such elements. In the practice of present invention, several technical features in the claim can be embodied by one component. In the claims, any reference signs placed between parentheses shall not be construed as limiting to the scope.

1. A method of determining a channel state, in a serving base station, wherein the serving base station performs a coordinated multipoint transmission with at least one coordinated base station, and the method comprises:
informing, through a cell-specific signaling, a user equipment to measure a first reference signal sent by the serving base station on corresponding communication resource, the first reference signal is used for the user equipment to determine first channel state information;
sending the first reference signal on the corresponding communication resource; and
informing, through a cell-specific signaling, the user equipment to measure second reference signals respectively sent by each of coordinated base station on corresponding communication resource, the second reference signal is used for the user equipment to determine second channel state information;
receiving the first channel state information and each of second channel state information fed back by the user equipment.

2. The method according to claim 1, wherein the method further comprises:
informing each coordinated base stations of the corresponding second channel state information respectively;
precoding a third reference signal according to the first channel state information, and sending the precoded third reference signal to the user equipment on the communication resource commonly used with the coordinated base station, wherein the third reference signal is superimposed with precoded fourth reference signals respectively sent by each of coordinated base stations;
receiving third channel state information fed back by the user equipment according to the superimposed reference signal, and determining a channel state of the coordinated multipoint transmission corresponding to the user equipment, according to the first, second and third channel state information.

3. The method according to claim 1, wherein, the communication resources on which the serving base station and the coordinated base station sends the first and second reference signals are respectively specific.

4. The method according to claim 2, wherein, prior to preceding, the method further comprises:
informing, through a cell-specific or user equipment-specific signaling, the user equipment to receive the superimposed third and fourth reference signals on the common communication resource.

5. The method according to claim 2, wherein the method further comprises:
determining a rank of the first channel state information;
determining an amount or port number of the third reference signal according to the rank of the first channel state information.

6. The method according to claim 2, wherein the method is used for MU-MIMO, and respectively determines the corresponding channel state of the coordinated multipoint transmission for each of a plurality of user equipments, the method further comprises:
determining a multi-users precoding matrix for the plurality of user equipments, based on the channel state of the coordinated multipoint transmission of each of the user equipments.

7. A method of controlling channel state feedback, in a coordinated base station, wherein the coordinated base station performs a coordinated multipoint transmission with a serving base station, and the method comprises:
receiving second channel state information between a user equipment and the coordinated base station, from the serving base station;
precoding a fourth reference signal according to the second channel state information, and sending the precoded fourth reference signal to the user equipment on a communication resource commonly used with the serving base station, wherein the fourth reference signal is superimposed with a precoded third reference signal respectively sent by the serving base stations.

8. The method according to claim 7, wherein, prior to the step i the method further comprises:
sending to the user equipment a second reference signal for the user equipment to determine the second channel state information on corresponding communication resource.

9. The method according to claim 7, wherein, the method further comprises:
determining a rank of the second channel state information;
determining an amount or port number of the fourth reference signal according to the rank of the second channel state information.

10. A method of feeding back a channel state, in a user equipment, wherein a serving base station to which the user equipment belongs performs a coordinated multipoint transmission with at least one coordinated base station, and the method comprises:
receiving an instruction indicating the user equipment to receive a first reference signal sent by the serving base station on corresponding communication resource, wherein the instruction is sent by the serving base station through a cell-specific signaling;
receiving an instruction indicating the user equipment to receive a second reference signal respectively sent by each of coordinated base station on corresponding communication resource, wherein the instruction is sent by the serving base station through a cell-specific signaling;
determining first channel state information with the serving base station according to the first reference signal, and respectively determining second channel state information with each of coordinated base stations according to respective one of the second reference signals;
feeding back the first and second channel state information to the serving base station.

11. The method according to claim 10, wherein, the method further comprises:
receiving a reference signal on a communication resource commonly used by the serving base station and the coordinated base station, the reference signal is superimposed by a third reference signal precoded by the serving base station and fourth reference signals respectively precoded by each of coordinated base station, and determining third channel state information according to the reference signal;
feeding back the third channel state information to the serving base station.

12. The method according to claim 10, wherein, the user equipment receives the first reference signal and each of second reference signal on communication resources specific for respective each of the serving base station and the coordinated base station.

13. A method of sending a reference signal to a user equipment in a serving base station, the serving base station performs a coordinated multipoint transmission with at least one coordinated base station, the method comprises:
sending the reference signal on communication resource commonly used with the coordinated base station;
wherein the commonly used communication resource utilizes muted resource element of the physical downlink shared channel.

14. A method of sending a reference signal to a user equipment in a coordinated base station, the coordinated base station performs a coordinated multipoint transmission with a serving base station, the method comprises:
sending the reference signal on communication resource commonly used with the serving base station;
wherein the commonly used communication resource utilizes muted resource element of the physical downlink shared channel.

15. A method of receiving a reference signal sent by base stations in a user equipment, a serving base station to which the user equipment belongs performs a coordinated multipoint transmission with at least one coordinated base station, the method comprises:
receiving the reference signal on communication resource commonly used by the serving base station and the coordinated base stations;
wherein the commonly used communication resource utilizes muted resource element of the physical downlink shared channel.
